(19) United States
(12) Patent Application Publication
(10) Pub. No.: US 2007/0229252 A1
(43) Pub. Date: Oct. 4, 2007

(54) Safety Monitoring and Locating System

(76) Inventors: Charles K. Collins, Alexandria, VA (US); Joseph Landa, Alexandria, VA (US)

Correspondence Address: IP STRATEGIES, 12 1/2 WALL STREET, SUITE I, ASHEVILLE, NC, 28801, US

(21) Appl. No.: 11/692,661

(22) Filed: Mar. 28, 2007

Related U.S. Application Data
(60) Provisional application No. 60/786,828, filed on Mar. 29, 2006.

(51) Int. Cl. G08B 1/08; G08B 13/14; G08B 23/00

(52) U.S. Cl. 340/539.13; 340/573.1

(57) ABSTRACT

A monitoring system includes a user unit and a base station. The user unit includes a radio beacon that transmits a radio signal identifying a particular user. The base station includes a radio receiver that receives the radio signal, a processor that formats the received radio signal for display on an output device, and an output device that displays an indication of reception of the radio signal and an indication of the identity of the user. The user unit can also include a sensor interface that receives an output signal from a sensor device, and a processor that formats the sensor device output signal for transmission by the radio beacon as a component of the radio signal. The base station processor can also format the received radio signal for display on the output device such that the content of the sensor device output signal is displayed.

### CROSS-REFERENCE TO RELATED APPLICATION

This is related to, and claims the benefit under 35 USC §119(e) of U.S. Provisional Application for Patent No. 60/786,828, which was filed on Mar. 28, 2006.

### FIELD OF THE INVENTION

The invention relates to safety and in particular to the monitoring of the wellbeing and location of personnel working inside large structures, or in any other isolated or enclosed environment. For example, the invention has particular application to maritime safety in monitoring the wellbeing and location of crew on board a ship.

### BACKGROUND OF THE INVENTION

Crew members of large ships often work in dangerous, confined spaces. They also often work alone or in areas where it is not practical to provide a safety watch. Due to the unique structure of most ships, conventional radios or other safety communications are not appropriate. Additionally, crewmembers on ships at sea are always at risk of falling overboard and becoming lost at sea. A need exists to monitor the location of crew members and also to provide an alert indication in case of an emergency. By placing a beacon on each crew member that can be monitored for motion and by which one can track personnel locations on a ship, every crew member's wellbeing can be monitored by a computer or alarm system regardless of their location on ship or the task they are performing.

Reference is made herein to use of the system of the invention on board a ship, and the monitoring of ship-board personnel, for convenience of description. It is contemplated that the present invention is applicable for use in connection with any large structure in which numerous personnel are located, or in any other environment that is enclosed or isolated, either physically or with respect to communication limitations. Details regarding ship-board use are not intended as a limitation of the invention.

### BRIEF SUMMARY OF THE INVENTION

According to an aspect of the invention, a monitoring system includes a user unit and a base station. The user unit includes a radio beacon that is adapted to transmit a radio signal identifying a particular user. The base station includes a radio receiver that is adapted to receive the radio signal, a base station processor that is adapted to format the received radio signal for display on an output device, and an output device that is communicatively connected to the base station processor and displays an indication of reception of the radio signal and an indication of the identity of the user.

The user unit can be adapted to be coupled to a user. The base station can be embodied as a portable device. Alternatively, the output device can be a portable device that is adapted to communicate wirelessly with other components of the base station.

The user unit can also include a sensor interface that is adapted to receive an output signal from a sensor device, and a user unit processor that is adapted to format the sensor device output signal for transmission by the radio beacon as a component of the radio signal. The base station processor can also be adapted to format the received radio signal for display on the output device such that the content of the sensor device output signal is displayed. The sensor interface can be adapted to receive the output signal from any of a number of different types of sensor devices. The user unit can also include a sensor device that is coupled to the sensor interface. The sensor device can be, for example, a moisture sensor, a motion sensor, an accelerometer, a temperature sensor, or a heart rate sensor. The system can also include a controller, communicatively coupled to the base station, that is adapted to control a device external to the system according to the received sensor device output signal. For example, the system can be disposed on a ship, and the external device can be the ship's engine controller. In this example, the received sensor device output signal can be a man overboard signal, and the controller can be adapted to switch the ship's engine controller to idle on reception of the sensor device output signal by the base station.

The system can include a number of user units and a network, and each user unit can be connected as a node of the network. For example, the network can be a wireless network, such as a mesh network. The system can also include at least one signal repeater that receives the radio beacon signal and re-transmits the radio beacon signal to a node of the network. The at least one signal repeater can be connected as a node of the network, and at least one signal repeater can be coupled for wired communication with at least the base station. For example, one signal repeater can be adapted for powerline communication with at least the base station. At least one node can be adapted to determine communication conditions of the network and to select between wired and wireless communication for the network depending on the determined communication conditions.

The plurality of user units can each include a respective radio beacon that is adapted to transmit a radio signal at a selected one of a plurality of selectable frequencies, and the wireless network can be adapted to operate at least the one selected frequency. At least one node can be adapted to determine communication conditions of the network and to determine the selected one of the plurality of selectable frequencies depending on the determined communication conditions.

The base station can be connected as a node of the wireless network.

The base station can include an alarm. For example, the base station can be adapted to actuate the alarm if the radio signal is not received by the base station within a predetermined time interval. The alarm can be, for example, an auditory alarm, a visual alarm, and/or a vibrational alarm.

The base station can include a transmitter, and the base station processor can be adapted to format the received radio signal for transmission of radio signal information by the transmitter to a remote receiver.

The system can also include at least one RFID tag, in which case the user unit includes a tag reader that is adapted to read a signature of the RFID tag. The RFID tag can include a passive signature, in which case the tag reader is adapted to read the passive signature. Alternatively, the tag reader can include a transponder that is adapted to interrogate the RFID tag, in which case the RFID tag is adapted to provide a signature in response to the interrogation, and the tag reader is adapted to read the signature. The user unit can include a user unit processor and a user unit memory device. The user unit processor can be adapted to store signature data corresponding to the read signature in the memory device. The user unit can also include a timing device that generates a timing signal, and the processor can be adapted to provide tag information that includes the signature data and a time value associated with the timing signal. The user unit processor can be adapted to include the signature data in the radio signal. The base station can include a base station memory device, and the base station processor can be adapted to store the signature data in the base station memory device.

In an alternative arrangement, the system can include at least one RFID tag reader, and the user unit can include an RFID tag. The tag reader can be adapted to read a user signature of the RFID tag. The RFID tag can include a passive signature, and the tag reader can be adapted to read the passive signature. Alternatively, the tag reader can include a transponder that is adapted to interrogate the RFID tag, in which case the RFID tag is adapted to provide a signature in response to the interrogation, and the tag reader is adapted to read the signature. The tag reader can include a transmitter that is adapted to transmit the user signature to the base station. The tag reader can transmit the user signature to the base station on receiving the user signature.

At least one of the at least one RFID tag reader can be coupled for wired communication with at least the base station. For example, the at least one of the at least one RFID tag reader can be adapted for powerline communication with at least the base station.

The tag reader can include a receiver and the base station can include a transmitter. The base station processor can be adapted to cause the transmitter to transmit a user signature request to the tag reader, and the tag reader can be adapted to receive the user signature request and to transmit the user signature to the base station on receiving the user signature request. The tag reader can include a memory device in which the user signature is stored. The tag reader can include a timing device that generates a timing signal, and the tag reader can be adapted to provide a time value associated with the timing signal and bound to the user signature. Alternatively, the user unit can include a timing device that generates a timing signal, and the user unit processor can be adapted to provide a time value associated with the timing signal and bound to the user signature.

### BRIEF DESCRIPTION OF THE DRAWINGS

FIG. 1 is a block diagram of an exemplary embodiment of the system of the invention.

FIG. 2 shows an exemplary embodiment of the user unit of the invention, shown worn by a user.

FIG. 3 is a block diagram of an exemplary embodiment of the user unit of the invention.

FIG. 4 is a block diagram of an exemplary embodiment of the base station of the invention.

FIG. 5 is a block diagram of an exemplary network according to a particular embodiment of the invention.

FIG. 6 is a block diagram of an exemplary embodiment of the base station of the invention.

FIG. 7 is a block diagram of an exemplary embodiment of the base station of the invention.

FIG. 8 is a block diagram of an exemplary embodiment of a tagging system of the invention.

FIG. 9 is a block diagram of an exemplary embodiment of a tagging system of the invention.

### DETAILED DESCRIPTION OF THE INVENTION

Various embodiments of the apparatus of the invention include individual beacon devices worn by crew members, tag readers (either active or passive), signal repeaters, and a base station. Each individual in the system wears a beacon device, which consists of a radio beacon, a wireless data network node, and a sensor interface that can indicate alarm conditions. Examples of alarm conditions include submersion in water, lack of motion, abnormal temperature, or abnormal pulse rate. Other sensors or biometrics can also be used. Each beacon can communicate with other beacons in a mesh network and as needed signal repeaters can be placed throughout the ship to ensure complete system coverage. Preferably, multiple modes of communication are available for use with the system, to provide flexibility and reliability in dealing with a challenging communication environment.

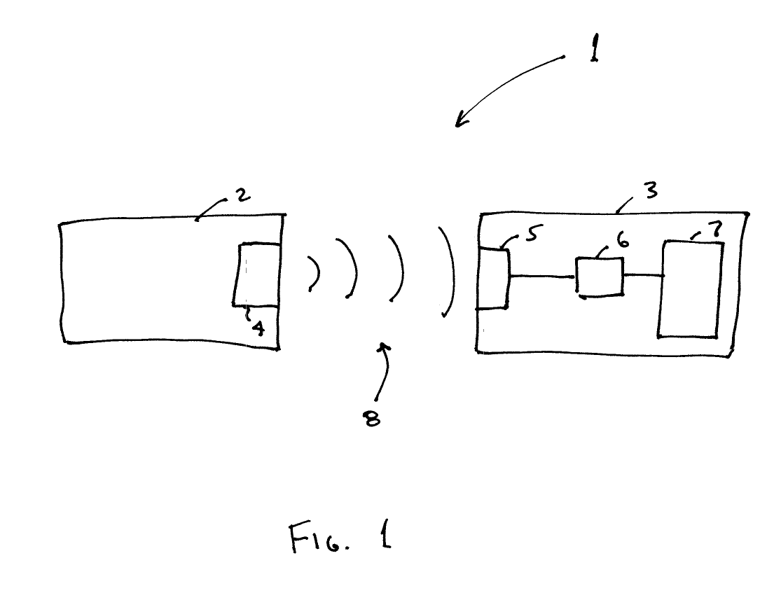

As shown in FIG. 1, a monitoring system 1 includes a user unit 2 and a base station 3. The user unit 2 is intended to be worn or carried by a user such as personnel on board a ship or working or otherwise spending time within a closed structure or environment. The user unit 2 includes a radio beacon 4 or other transmitter that transmits a radio signal 8, preferably periodically or according to a predetermined timed sequence. The radio signal 8 includes information identifying the user associated with the user unit 2, and might include other information such as the time. The information carried by the radio signal 8 can be arranged in predetermined fields, or can otherwise be included in the signal such that the information can be recognized and decoded by the base station, using any arrangement known to those in the art.

The base station 3 includes a radio receiver 5 that receives the radio signal 8. A processor 6 in the base station 3 decodes the received radio signal 8 so that the information included in the signal 8 is formatted and displayed on an output device 7. The output device 7 displays an indication that the radio signal 8 was received, and also provides an indication of the identity of the user associated with the received signal 8. For example, the output device can display a visual indication of reception of the beacon signal, in a display field that is designated for the user associated with the received signal. Alternatively, a designation, such as an identification number associated with the user, can be presented on the output device 7. As another alternative, the processor 6 can decode the information included in the signal in such a way as to cause the output device to display the name of the associated user, such as through the use of a look-up table.

As shown in FIG. 2, the user unit 2 can be adapted to be worn by or attached to a user, such as by a clip 9 that can attach to the user's belt or pocket, or through the use of any other attachment mechanism. Alternatively, the user unit 2 can be carried by the user, such as in a pocket or backpack. Preferably, the base station 3 is a desk-top type device, although it can be embodied as a portable device. Alternatively, the base station can be primarily a desk-top device, and the output device 7 can be a portable device that communicates wirelessly with other components of the base station 3. In such an embodiment, the output device 7 can be attached to or worn by personnel monitoring the base station 3, and preferably docks in the base station 3 when not in portable use. Of course, the base station 3 can include a portable auxiliary output device in addition to a fixed output device in the main portion of the base station.

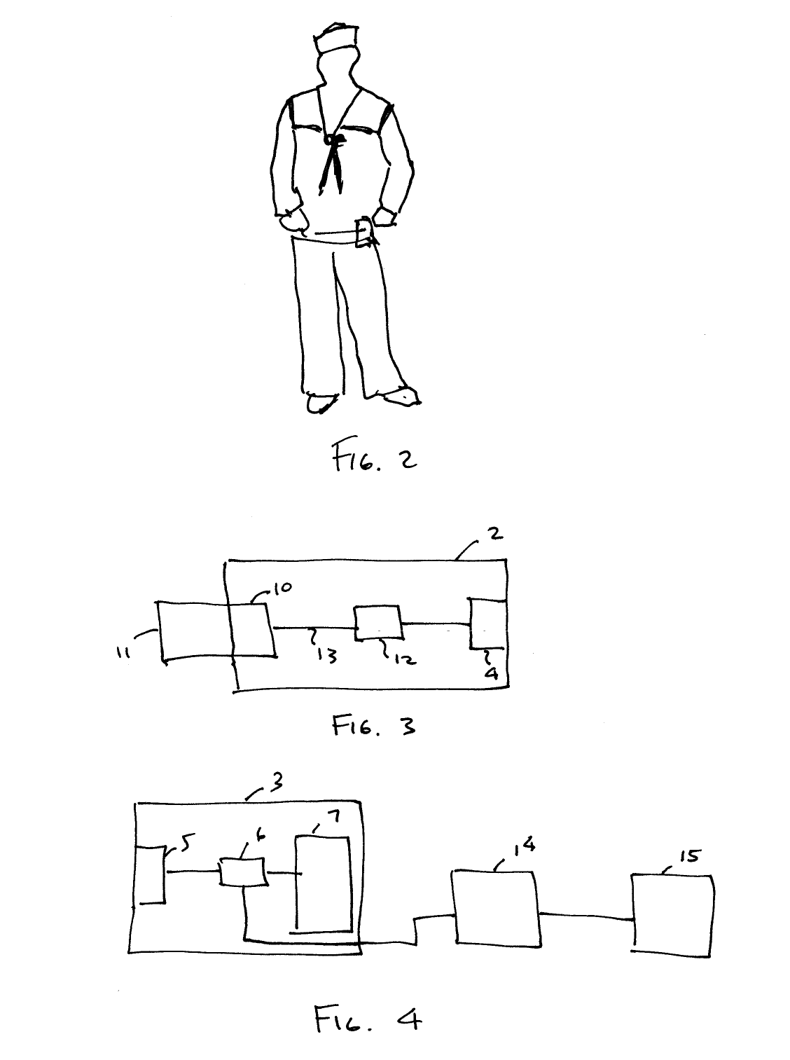

As shown in FIG. 3, particular embodiments of the user unit 2 allow the user unit 2 to communicate with external sensors, which provide information about the user and/or the user's environment to the user unit 2, which in turn can provide this information to the base station 3 as part of the radio signal 8. This embodiment of the user unit 2 includes a sensor interface 10 that receives an output signal from a sensor device 111 that can be coupled to the user unit 2. A user unit processor 12 formats the sensor device output signal 13 for transmission by the radio beacon 4 as a component of the radio signal 8. The base station processor 6 in turn formats the received radio signal to display the content of the sensor device output signal 13 on the output device 7.

Multiple sensor interfaces can be provided on the user unit 2, so that different types of sensors can be used. Alternatively, the sensor interface 10 can be designed to receive the output signal from any of a number of different types of sensor devices, through the use of an appropriate physical interface and device recognition features as known to those of skill in the art. It is contemplated that an embodiment of the user unit 2 will include a sensor device 11 as an integrated component of the user unit 2.

Typical sensor devices used as described above would be, for example, a moisture sensor, a motion sensor, an accelerometer, a temperature sensor, a heart rate sensor, or any other type of biological, physical, chemical, physiological, or environmental sensor that is appropriate for the setting in which the system 1 is used, the task a user might perform, or the environment to which the user is exposed. A moisture sensor would be useful, for example, on shipboard, as an indication that the user might have fallen overboard the ship. In place of a conventional moisture sensor, an overboard indication device, such as that described in U.S. Pat. No. 5,886,635, can be provided with an interface that is compatible for use with the user unit 2, such that an overboard indication signal is provided to the user unit 2 and then transmitted to the base station 3.

A motion sensor can be used to determine whether a user is motionless for a long period of time, which could indicate that he or she is unconscious. The user unit 2 can process the output of a motion sensor and, if the motion sensor indicates no motion for a period of time that exceeds a predetermined threshold, the radio beacon signal 8 can include information alerting personnel monitoring the base station 3 that the user is immobile. Alternatively, the motion information provided by the motion detector can be provided with every transmission of the beacon signal 8, and the base station processor 6 can make the threshold determination before alerting monitoring personnel. In either case, the threshold preferably is adjustable.

An accelerometer can be used to determine whether a user's rate of motion changes significantly, which could indicate that he or she has fallen. The user unit 2 can process the output of an accelerometer and, if the accelerometer indicates acceleration that exceeds a predetermined threshold, the radio beacon signal 8 can include information alerting personnel monitoring the base station 3 that the user has likely fallen. Alternatively, the acceleration provided by the accelerometer can be provided with every transmission of the beacon signal 8, and the base station processor 6 can make the threshold determination before alerting monitoring personnel. In either case, the threshold preferably is adjustable.

In certain situations, a user might be assigned a task that requires exposure to heat or chemicals. A temperature sensor or chemical sensor, as appropriate, can be used to determine whether a user is exposed to heat or chemicals to a dangerous extent or for a dangerously long period of time. The user unit 2 can process the output of the sensor and, if the sensor indicates exposure to a level of heat or chemical concentration that exceeds a predetermined threshold or for a period of time that exceeds a predetermined threshold, the radio beacon signal 8 can include information alerting personnel monitoring the base station 3 that the user is likely in danger. Alternatively, the information provided by the sensor can be provided with every transmission of the beacon signal 8, and the base station processor 6 can make the threshold determination before alerting monitoring personnel. In either case, the threshold preferably is adjustable.

A physiological sensor, such as a heart rate sensor, can be used similarly to the sensors described above in order to monitor the user directly.

In certain situations, the status reported by the user unit 2 will require a response by the ship's physical plant or other system in order to safeguard the well-being of the user. For example, if a sensor coupled to the user unit 2 indicates a man overboard situation, idling the ship's engines would make a rescue operation less difficult and more likely successful. Thus, certain embodiments of the system 1 include a provision for automatically controlling certain of the ship's systems in response to the content of the beacon signal 8. As shown in FIG. 4, the exemplary embodiment of the system 1 includes a controller 14, communicatively coupled to the base station 3, that is adapted to control a ship-board system or any other appropriate device 15 external to the system 1, in response to the received sensor device output signal. For example, the external device 15 can be the ship's engine controller, which can be caused to automatically shut down or idle in response to an indication that a user has fallen overboard.

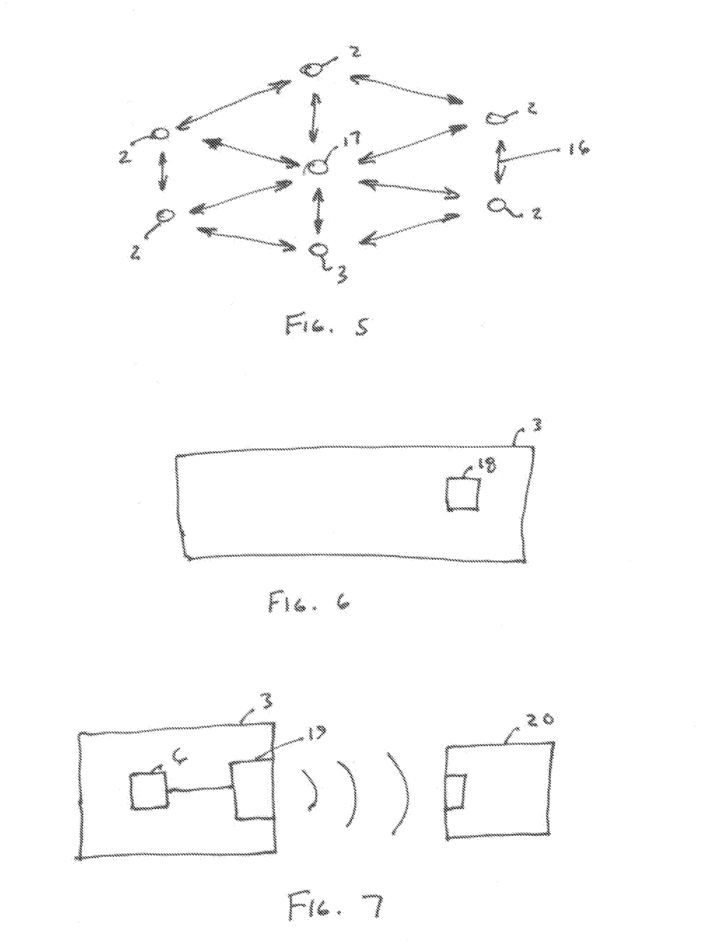

As shown in FIG. 5, the system can include a plurality of user units 2, each associated with a different user. According to a preferred embodiment, the system 1 includes a wireless network 16, and each user unit is connected as a node of the wireless network 16. For example, the wireless network 16 can be a mesh network, which provides an indication of the relative position of each user unit 2 with respect to other user units that are part of the network. The mesh network 16 preferably utilizes a full mesh topology in which each user unit node is connected to each other user unit node and the base station node, although other topologies, such as a partial net topology, can be used, as well as any combination of star, cluster tree, and mesh topologies. Such a network 16 can handle many-to-many connections, and preferably is capable of dynamically optimizing and updating these connections. Preferably, the base station node is the network coordinator. A well-known example of a suitable mesh network is the ZigBee network, which only requires low power consumption and therefore provides long battery life, although it is contemplated that other standard and custom mesh networks can be used advantageously as part of the system 1. The base station 3 can track relative locations of the user units 2 over the mesh network 16 to assist in locating a user who needs assistance.

In order to provide coverage that is as complete as possible, the system 1 can also include at least one signal repeater 17 to facilitate network connectivity among the nodes. The signal repeaters 17 can receive the radio beacon signal 8 and re-transmit it to a node of the wireless network 16 to facilitate reception of the beacon signal 8 by the base station 3.

In addition, any of the signal repeaters 17 can be connected as a node of the network 16, coupled for wired communication with at least the base station 3. Under circumstances that are not optimum for reliable wireless communication, the wired signal repeaters can communicate over a wired channel to the base station 3 or any other node, in order to increase the reliability of the system 1. The wired channel can be part of a dedicated communication link, or the signal repeaters can be connected for powerline communication. One node can be designed as an intelligent node that determines communication conditions of the network and selects between wired and wireless communication for the network depending on the determined conditions, so as to retain for the system 1 the benefits of the complete network when conditions allow.

Likewise, the user unit radio beacons can have multiple selectable beacon frequencies, one of which is selected for operation at any time. Users will be instructed when logging in with the base station 3 to select the transmission frequency that is then in use. According to a preferred embodiment, one node can be an intelligent node that determines communication conditions of the network. This intelligent node then selects the optimum transmission frequency depending on the determined conditions, and sets all nodes to communicate at that frequency.

When the base station 3, connected as part of the mesh network, receives a beacon signal 8 from a user unit 2, the base station will be able to provide at least a coarse indication of the position of the user unit 2 relative to other user units on the network, as well as to the base station as a node of the network. This indication of position will aid monitors at the base station in responding quickly to emergency situations indicated by the beacon signal 8. Also, automatic controls as described previously can be enhanced through knowledge of the user unit's position. For example, in the case of a man overboard situation, the network position of the user unit 2 might indicate the side of the ship over which the user likely fell. If, for example, the indication is that the user has fallen over the starboard side of the ship, the controller 14 can cause the ship to turn hard to starboard prior to idling, in order to turn the ship's props away from the fallen user to avoid injury to the user.

As shown in FIG. 6, a particular exemplary embodiment of the base station 3 includes an alarm device 18 that can be used in emergency situations, in order to get the attention of the monitoring personnel at the base station 3 to draw attention to the more detailed indication on the output device 7, or to draw attention to a missing beacon. For example, the base station 3 can actuate the alarm device 18 if the radio signal 8 from a particular user is not received by the base station 3 within a predetermined time interval, possibly indicating a malfunction of the user unit 2, but also possibly indicating that the associated user is experiencing trouble and requires assistance. The alarm device 18 can be, for example, an auditory alarm, a visual alarm, and/or a vibrational alarm. The alarm device 18 can be a portable component of the base station 3, preferably with wireless communication to the main component of the base station 3, so that monitoring personnel can carry or wear the alarm device 18 when away from the main base station 3.

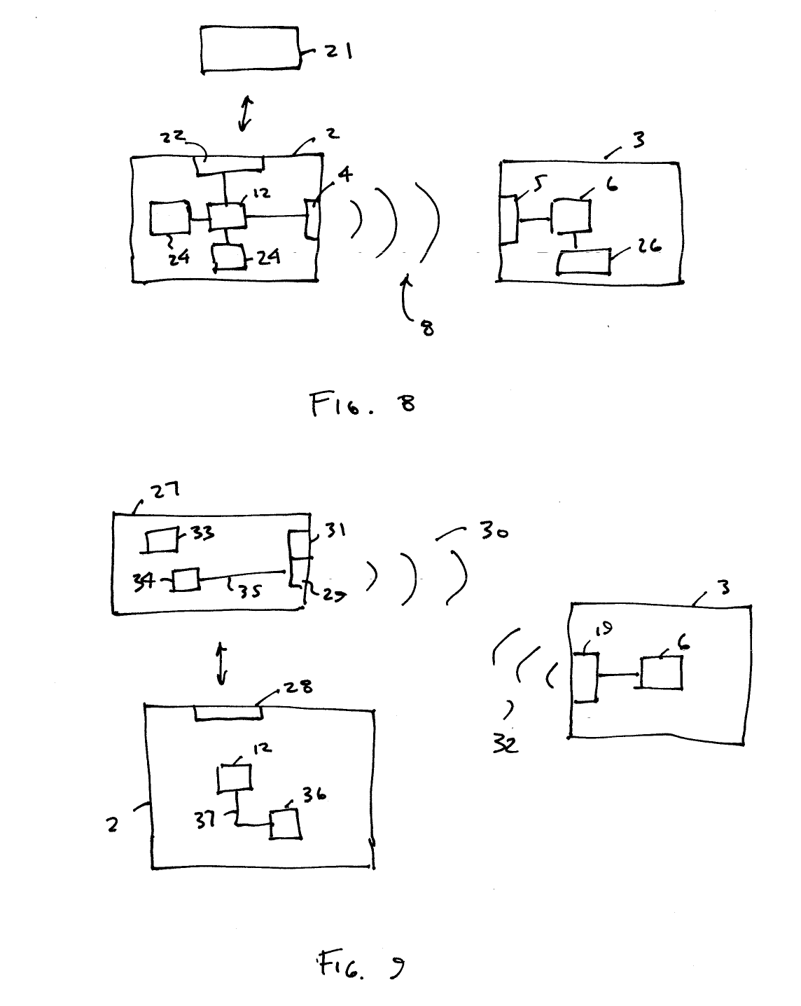

In certain situations, it will be helpful or necessary to call for outside assistance to help a user. For example, in the man overboard situation described above, it might be useful to signal a small nearby ship to assist in bringing recovering the person in the water. As shown in FIG. 7, a particular exemplary embodiment of the base station 3 includes a transmitter 19. The base station processor 6 of this embodiment formats the received radio signal such that relevant information in the signal is transmitted by the transmitter 19 to a remote receiver 20, such as a receiver on a nearby ship. Additional information or a message can be added by base station personnel through the use of an appropriate input device such as a keyboard, or a standard message can be read from memory and added to the beacon signal information by the processor 6. Two-way communication with the remote entity is also possible.

Instead of using the mesh network, or in combination with use of a network, the system 1 can use RFID technology to track the movements of personnel carrying user units 2. An RFID arrangement including tags and readers can be used to effectively track and log personnel movement. The tags can be located at appropriate places within the confines of the system 1, such as at entryways and ladders, and the user unit 2 can include a reader to capture and log tag locations as the user passes the tags. Alternatively, each user unit 2 can include a tag, and appropriately-placed readers can read the users' tags and log movement past the readers. In either case, the RFID tagging system used can function at a short range to provide information about personnel passing key areas.

For example, as shown in FIG. 8, a particular embodiment of the system 1 includes at least one RFID tag 21 placed in a suitable location, and the user unit 2 includes a tag reader 22 that reads a signature of the RFID tag 21. Each user unit 2 that includes an RFID tag 21 will provide a different RFID signature, so that as signatures are read by the tag reader 22, the associated user is identified. The RFID tag 21 can include a passive signature, or the tag 21 can actively generate a signature signal. If the signature is passive, such as an arrangement of conductive elements on the tag 21, the tag reader 22 will read the passive signature, such as by illuminating the tag 21 with RF energy and reading the resulting signature. In active signature systems, the tag reader 22 includes a transponder that interrogates the RFID tag 21. The active RFID tag 21 provides a signature signal in response to the interrogation, and the tag reader 22 reads the signature. Active RFID tags require circuitry to recognize a valid interrogation and reply with a signal that is generated as a proper signature. The interrogation/reply sequence can be encrypted according to certain embodiments of the invention, if security is a concern.

As shown in FIG. 8, this embodiment of the user unit 2 also includes a user unit memory device 23. The user unit processor 12 causes signature data corresponding to the read signature to be stored in the memory device 23, so as to create a log in which the sequence of user movement is stored. In this embodiment, the user unit 2 can also include a timing device 24, such as an oscillator or a digital counter, which generates a timing signal 25. The timing signal 25 can correspond to the time of day, to an elapsed time, or to any other timing framework used by the system 1. The processor 12 provides tag information that includes the signature data and a time value associated with the timing signal 25. The signature data and the associated time value can be bound together or combined in any manner to produce the tag information, which can be stored in the memory device 23 so that the user log can include timing information. The user unit processor 12 then includes the tag information in the beacon radio signal 8 that is transmitted to the base station 3. The base station 3 preferably includes a memory device 26 in which the tag information is stored. If a timing device is not used in a particular embodiment of the system 1, then only the signature data is included in the beacon radio signal 8 and stored in the memory device 26. If the system 1 includes a network as described above, the tag information can be passed none-to-node until it reaches the base station 3, and relative positions of the nodes can be noted at tag-reading events.

In an alternative arrangement, as shown in FIG. 9, the system 1 includes at least one RFID tag reader 27 placed in a suitable location, and the user unit 2 includes an RFID tag 28. The tag reader 27 reads a user signature of the RFID tag 28. Similar to the previous embodiment, the RFID tag 28 can include a passive signature, and the tag reader 27 reads the passive signature. Similar to the alternative embodiment described above, the tag reader 27 can include a transponder that interrogates the RFID tag 28, in which case the RFID tag 28 provides a signature in response to the interrogation and the tag reader 27 reads the signature.

The tag reader 27 of this embodiment can include a transmitter 29 that transmits the received user signature 30 to the base station 3. This transmission can occur on receipt by the tag reader 27 of the user signature, or on request by the base station 3. For example, the tag reader 27 can include a receiver 31 that receives requests from the base station transmitter 19. The base station processor 6 causes the transmitter 19 to transmit a user signature request 32 to the tag reader 27, and the tag reader 27 receives the user signature request 32 and in response transmits the user signature 30 to the base station 3.

In certain embodiments of the invention, at least one tag reader 27 is coupled for wired communication with at least the base station, in order to add flexibility and reliability to the system 1. For example, one tag reader 27 can be connected for powerline communication with at least the base station.

In a preferred embodiment, the tag reader 27 also includes a memory device 33 in which the user signature is stored, and a timing device 34 that generates a timing signal 35. The tag reader 27 provides a time value associated with the timing signal 35, which is bound to or otherwise combined with the user signature to provide tag information. Alternatively, the user unit 2 can include a timing device 36 that generates a timing signal 37 and provides a time value that is bound to the user signature. In either case, according to this embodiment, the tag information can be transmitted to the base station, instead of just the user signature.

As described, the invention satisfies the need to track personnel locations in the event of emergency or a damage-control situation. The system provides an alert in the event of a person down, provides an indication of the physical stress of personnel performing certain tasks, and provides other alerts, such as an alert of a man overboard

We claim:

1. A monitoring system, comprising:
a user unit; and
a base station;
wherein the user unit includes a radio beacon that is adapted to transmit a radio signal identifying a particular user; and
wherein the base station includes
a radio receiver that is adapted to receive the radio signal,
a base station processor that is adapted to format the received radio signal for display on an output device, and
an output device that is communicatively connected to the base station processor and displays an indication of reception of the radio signal and an indication of the identity of the user.

2. The system of claim 1, wherein the user unit is adapted to be coupled to a user.

3. The system of claim 1, wherein
the user unit further includes
a sensor interface that is adapted to receive an output signal from a sensor device, and
a user unit processor that is adapted to format the sensor device output signal for transmission by the radio beacon as a component of the radio signal, and
the base station processor is further adapted to format the received radio signal for display on the output device such that the content of the sensor device output signal is displayed.

4. The system of claim 3, further comprising a controller, communicatively coupled to the base station, that is adapted to control a device external to the system according to the received sensor device output signal.

5. The system of claim 4, wherein the system is disposed on a ship, and wherein the external device is the ship's engine controller.

6. The system of claim 5, wherein the received sensor device output signal is a man overboard signal, and the controller is adapted to switch the ship's engine controller to idle on reception of the sensor device output signal by the base station.

7. The system of claim 3, wherein the sensor interface is adapted to receive the output signal from any of a number of different types of sensor devices.

8. The system of claim 3, wherein the user unit includes a sensor device that is coupled to the sensor interface.

9. The system of claim 8, wherein the sensor device is selected from the group consisting of moisture sensors, motion sensors, accelerometers, temperature sensors, and heart rate sensors.

10. The system of claim 1, comprising a plurality of user units and a network, wherein each said user unit is connected as a node of the network.

11. The system of claim 10, wherein the network is a wireless network.

12. The system of claim 11, wherein the wireless network is a mesh network.

13. The system of claim 10, further comprising at least one signal repeater that receives the radio beacon signal and re-transmits the radio beacon signal to a node of the network.

14. The system of claim 13, wherein the at least one signal repeater is connected as a node of the network.

15. The system of claim 14, wherein at least one of the at least one signal repeater is coupled for wired communication with at least the base station.

16. The system of claim 15, wherein the at least one of the at least one signal repeater is adapted for powerline communication with at least the base station.

17. The system of claim 15, wherein at least one node is adapted to determine communication conditions of the network and to select between wired and wireless communication for the network depending on the determined communication conditions.

18. The system of claim 17, wherein the base station is connected as a node of the wireless network.

19. The system of claim 10, wherein the base station is connected as a node of the wireless network.

20. The system of claim 10, wherein the plurality of user units each includes a respective radio beacon that is adapted to transmit a radio signal at a selected one of a plurality of selectable frequencies, and wherein the wireless network is adapted to operate at least the one selected frequency.

21. The system of claim 20, wherein at least one node is adapted to determine communication conditions of the network and to determine the selected one of the plurality of selectable frequencies depending on the determined communication conditions.

22. The system of claim 21, wherein the base station is connected as a node of the wireless network.

23. The system of claim 1, wherein the base station includes an alarm.

24. The system of claim 23, wherein the base station is adapted to actuate the alarm if the radio signal is not received by the base station within a predetermined time interval.

25. The system of claim 23, wherein the alarm is at least one of an auditory alarm, a visual alarm, and a vibrational alarm.

26. The system of claim 1, wherein the base station includes a transmitter, and the base station processor is adapted to format the received radio signal for transmission of radio signal information by the transmitter to a remote receiver.

27. The system of claim 1, further comprising at least one RFID tag, wherein the user unit includes a tag reader that is adapted to read a signature of the RFID tag.

28. The system of claim 27, wherein the RFID tag includes a passive signature, and the tag reader is adapted to read the passive signature.

29. The system of claim 27, wherein the tag reader includes a transponder that is adapted to interrogate the RFID tag, the RFID tag is adapted to provide a signature in response to the interrogation, and the tag reader is adapted to read the signature.

30. The system of claim 27, wherein the user unit includes a user unit processor and a user unit memory device, wherein the user unit processor is adapted to store signature data corresponding to the read signature in the memory device.

31. The system of claim 30, wherein the user unit includes a timing device that generates a timing signal, and the processor is adapted to provide tag information that includes the signature data and a time value associated with the timing signal.

32. The system of claim 30, wherein the user unit processor is adapted to include the signature data in the radio signal.

33. The system of claim 32, wherein the base station includes a base station memory device, wherein the base station processor is adapted to store the signature data in the base station memory device.

34. The system of claim 1, further including at least one RFID tag reader, wherein the user unit includes an RFID tag and the tag reader is adapted to read a user signature of the RFID tag.

35. The system of claim 34, wherein at least one of the at least one RFID tag reader is coupled for wired communication with at least the base station.

36. The system of claim 35, wherein the at least one of the at least one RFID tag reader is adapted for powerline communication with at least the base station.

37. The system of claim 34, wherein the RFID tag includes a passive signature, and the tag reader is adapted to read the passive signature.

38. The system of claim 34, wherein the tag reader includes a transponder that is adapted to interrogate the RFID tag, the RFID tag is adapted to provide a signature in response to the interrogation, and the tag reader is adapted to read the signature.

39. The system of claim 34, wherein the tag reader includes a transmitter that is adapted to transmit the user signature to the base station.

40. The system of claim 39, wherein the tag reader transmits the user signature to the base station on receiving the user signature.

41. The system of claim 39, wherein
the tag reader includes a receiver,
the base station includes a transmitter,
the base station processor is adapted to cause the transmitter to transmit a user signature request to the tag reader, and
the tag reader is adapted to receive the user signature request and to transmit the user signature to the base station on receiving the user signature request.

42. The system of claim 34, wherein the tag reader includes a memory device in which the user signature is stored.

43. The system of claim 34, wherein the tag reader includes a timing device that generates a timing signal, and the tag reader is adapted to provide a time value associated with the timing signal and bound to the user signature.

44. The system of claim 34, wherein the user unit includes a timing device that generates a timing signal, and the user unit processor is adapted to provide a time value associated with the timing signal and bound to the user signature.

45. The system of claim 1, wherein the base station is a portable device.

46. The system of claim 1, wherein the output device is a portable device that is adapted to communicate wirelessly with other components of the base station.
